(19) United States
(12) Patent Application Publication
(10) Pub. No.: US 2007/0206521 A1
(43) Pub. Date: Sep. 6, 2007

(54) Wireless Utility Monitoring And Control Mesh Network

(76) Inventor: Emeke Emmanuel Osaje, Hull (GB)

Correspondence Address: MR. EMEKE EMMANUEL OSAJE, 37 LAKESIDE GROVE, HULL, NORTH HUMBERSIDE, HU4 6NB, GB

(21) Appl. No.: 11/308,065

(22) Filed: Mar. 5, 2006

(51) Int. Cl. H04B 7/14; H04J 3/08; H04J 1/10

(52) U.S. Cl. 370/315

(57) ABSTRACT

A scalable distributed wireless control and monitoring system for managing utility supply over a wide geographical area. Such distributed networks can manage/control electricity, gas, water and other petroleum product supply to a large geographical area. The network consist of plurality of nodes that control and monitor utility usage at subscriber point; these nodes are called activityNode. The ActivityNodes can communicate with one or plurality of superNodes. The superNodes act as center for control and management for the activityNodes. The superNode can send “instruction to disconnect” a subscriber to an ActivityNode. A superNode can exchange data with one or plurality of neighboring superNodes. An aggregate of superNodes can poll data from plurality of activityNodes on the network, this information can be analyzed to determine the network performance and can also be use to preempt fault on any part of the network.

### BACKGROUND OF THE INVENTION

1. Field of the Invention

This invention relates to wireless meter monitoring and control for utility supply to subscribers in a wide geographical area, and particular emphasis to monitoring for leaks and failure on petroleum pipeline.

2. Related Art

Remote telemeter and control for utility supply to urban and rural communities is on the increase. In many cases, Energy and utility supplier rely on the customers to provide the meter reading. In societies where communication infrastructures are well developed, the customer send the meter reading to the utility provider through any of the available communication media.

In third world countries were a large majority of the population are not literate, it is practically impossible for the utility provider to ask the consumers to provide the meter reading. When the Energy or the utility provider realize that they cannot get most the utility meter reading through the customers, the providers have made effort to get the meter reading without the customer's help. Some of the techniques employed by the Utility providers include:
Sending employees out to take the meter reading from the customer's premises at the end of the billing cycle.
Install prepaid meters and mandate that the customers purchase prepaid cards.
Installing additional data cable to the meters to get the readings back.
For electricity supplier, they attempt to superimpose data communication over the power line.
Point to Point or Point to Multi-Point wireless telemeter.

Each of the options listed above will require that the utility provider invest large sum of money for the initial installation and in some of the cases, the recurrent expenditure incurred by the utility provider account for a large percentage of the revenue collected from the customers at the end of the billing period. In the instance where the employees of the Energy or Utility provider go round the customers premises to capture the meter reading is plagued by diverse factors. The drawback includes: it might not always be possible for the employee to gain access to the customer meter at the time of visit. If this is the case, the employee will have to make a repeat visit to the same customer. For every billing cycle, to ensure that the provider get all meter reading, multiple repeat visits to customers become inevitable. This method also leaves the utility provider lagging the billing cycle. Most of the bills do not reflect the utility consumed by the subscriber for that current billing period.

When the utility provider installs pre-paid meters, this will imply that the provider will have to franchise the sales of the prepaid meter cards to several retail outlets. For this franchise to succeed, the provider should be prepared to share a percentage of the billing revenue with the retail outlet. This will become a recurring expenditure to the provider. Some energy providers have opted to connect multi-drop data cables to their utility meter at every customer point. This investment will be worth the initial installation cost if it was deployed in highly populated urban settlements. For cases where the customers are dispersed over large geographical region, then the investment becomes too expensive to justify the cost.

Many other providers have made bold leaps in an attempt to improve on the above options; they strived to achieve this by installing wireless telemeters. Because the technology being deployed in the past was based on either point to point or point to multipoint wireless, the technology was successful for urban societies, where the population density is high. The limitations suffered by these technologies include: the limit of the range of the radio transmitter to the base station and the “line of sight” LOS limitation. The expansion of the traditional point to point or point to multipoint wireless require careful planning and adhoc expansions are not always successful. The planning is to ensure that the base station is located in a place where the most number of customers can be served. In cases where customers fall outside the base station radio frequency range, an alternate arrangement to get the customer's data unto the network need to be made.

For all of these technologies, none provided a robust option for the utility provider to gain control over the customer's meter. For cases where the Energy or utility provider need to isolate a particular customer from their distribution network, for some maintenance or financial reasons, these technologies did not provide an option. In other cases where there is a need for such isolation, the most likely option is for an employee to physically go to the customer to effect the isolation. It is important for Energy or Utility providers to produce and distribute their services, it is also essential for them to be able to measure the performance of their distribution network without having to install multiple specialized measuring devices at strategic points across their network. It is the wish of these providers to be able to use the telemetric devices installed at the customers point to generate the profile and measure the performance of their network. This way a better performance index can be achieved. Also paramount to the success of the Provider's business is the need for accurate measure and timely account of the utility supplied to a consumer. Most providers could not leverage this functionality, because there were no means of getting real-time network performance data from all customers in the past without physical cables.

Metering of water or gas supply to communities have suffered the most set back in term of billing. Most of the providers here solely rely on the customers to provide the data. There were attempts in the past to install some form of meter to measure the volume of water or gas delivered to the customer. These telemeter options were greatly set back by the following:
How to connect the meters back to the Gas or water supplier for accurate online reading
How to power the meters without having to rely on the customer to provide power for the meters.

Several other factors did not favor the advancement for this range of telemeters. Most companies that transport petroleum products through pipelines may not be so concerned to measure the volume of the product passing through the pipeline at intermittent point along the pipeline. This is simply due to the fact that most of these companies can measure the volume of the product that is leaving the source and can also measure the volume that reaches the destination. Any discrepancy between the volume at the source and that, which reaches the destination, may be referred as losses. The actual cause and point of these losses might not be worth investigating provided that the loss volume is far less than the volume that reaches the destination. In other cases, the losses are not investigated if no complaint is received.

In extreme situations, for cases of petroleum product losses to be investigated, the company will have to shut the pipeline down and deploy the intelligent pigging. This is a very expensive venture for most companies. As a result, there is a need for an easy to deploy, expandable distributed wireless mesh network for telemeter to overcome the limitations listed above and thus make the meter readings available to the provider and also grant them access and control over every point on their distribution network.

### BRIEF SUMMARY OF INVENTION

In accordance with some embodiment of the present invention, distributed wireless utility management network, wherein control and access method using code, time, direction and frequency diversity/variations are provided. Wireless utility management is provided to a plurality of location and wireless data access if achieved to and from a plurality of locations dispersed across a wide geographical region. Different structure for these control and access networks are provided depending on the kind of utility being distributed. The system allows for a large number of telemeters fitted with wireless transmitters to form a mesh network without loss of control due to collision on the network.

In accordance with one embodiment of the present invention, a distributed wireless control and communication network is provided that includes a plurality of locations, each having dual transceivers connected to two dedicated antennas. Wherein the transceivers are adapted to transmit or receive a radio frequency signal by selecting a channel from at least two non-conflicting channels. These wireless utility meter and transceivers are called ActivityNode and a distributed wireless utility management mesh network is made up of plurality of ActivityNode and one or more management node called the SuperNode. All activityNodes attach to the network and ultimately gain connection to the superNode and any valid activityNode in this network becomes a potential point of attachment for other activityNode to the network. A tree structure is formed that originates at the superNode and branches out from the superNode to one or more activityNodes, within a geographical area; wherein the geographical area can span far beyond the radio frequency range of the superNode. This wide coverage is achieved because all activityNodes on a network act a repeater node. Signal can hop across multiple repeater nodes to reach its destination on the network.

Moreso, in accordance with some embodiment of the present invention, activityNodes on the network require two independent communication channels from a number of available channels. This reserve number of channels belongs to the same frequency band, the variations in the channels are derived from code, time, frequency or directional diversities. These diversities allow access and control from a superNode to plurality of activityNodes at the same time without collision or losses. The network does not require dedicated repeater nodes to be deployed so as to expand the network, but rather each activityNode can play the role of a repeater node for its neighbor whilst still performing its own internal operation and communication.

The throughput and processing power of the superNode determines the number of activityNodes that can be on a network. New superNode(s) can be added to an existing network. When this is done the superNodes can synchronize and exchange data without the need for a restart. When multiple superNodes exist in a network, the superNodes can create virtually segment on the network, this way data communication and reliability for control action will be significantly improved. The activityNodes on these networks are identical and as such the nodes could be moved seamlessly from one mesh network to another. This move across the network will be transparent to the subscriber. When a new activityNode attaches to a wireless utility mesh network, the superNode on that network will have to determine if the node was previously registered on any other network. This check is possible because superNodes across different network share details of nodes registered on their networks. If the new node was registered on another network, the new superNode will then attempt to retrieve the nodes registration details from the previous superNode or from a central superNode which hold details from plurality of superNodes that is part of a segmented and distributed wireless mesh network.

In accordance with another embodiment of the present invention, a method of control and communication on a wireless network deployed along a petroleum product pipeline; where the network comprise of a superNode and plurality of activityNodes. Wherein each activityNode can communicate with at least three other activityNodes in the upstream and downstream directions respectively. In this case, the reliability of communication is based on the number of similar nodes that an activityNode can communicate with in either direction. If one of the neighbors to a particular activityNode in one direction fails, that activityNode can still hop messages using at least two other nodes in that direction. The link in the network will be broken when all neighbors that an activityNode can reach in one direction fail to respond or communicate.

A better understanding of the embodiments of the present invention for distributed wireless utility management network system and methods will be afforded to those skilled in the art, as well as a realization of additional advantages thereof by a consideration of the following detailed description of one or more embodiments. Reference will be made to the appended sheets of drawing that will first be described briefly.

### BRIEF DESCRIPTION OF THE DRAWINGS

FIG. 1: Block diagram of network topology: This is a typical network installation for subscribers to a utility supply in a community

FIG. 2: Simplified network graph representation of the network of FIG. 1: This show the communication paths for wireless data exchange across the network. In this case, the solid lines are the active and preferred hop paths while the broken lines show other paths that nodes could use for communication across the network.

FIG. 3: Two independent mesh networks with a superNode bridge: This shows that classic case where two separate utility mesh networks can be merged into one larger network.

FIG. 4: Multi-mesh networks with collaborating SuperNodes. This shows that classic case where multiple utility mesh networks can be merged into one larger network.

FIG. 5: Multiple mesh networks with collaborating SuperNodes plus One Central Controller. This shows that classic case where multiple utility mesh networks can be merged into one larger network with one superNode assigned a the center for control. The central superNode keeps a list of all activityNodes on the separate mesh networks.

FIG. 6: Flow chart for the activityNode operation: Illustration of the modes of operation of the activityNodes. FIG. 7: Petroleum Pipeline mesh with single superNode: Network of nodes for monitoring petroleum pipeline.

FIG. 8: Petroleum Pipeline mesh with multiple superNodes: More reliable network of nodes for monitoring petroleum pipelines.

FIG. 9: Flow chart for the SuperNode operation: Illustration of the modes of operation of the superNodes.

FIG. 10: ActivityNode Internal Structure: Internal organization of components in the activityNodes.

FIG. 11: SuperNode Internal Structure: Internal organization of components in the SuperNodes.

FIG. 12: Multi-Hop message with header showing preferred hop path to the superNode.

FIG. 13: Petroleum Pipeline topology with multiple pipeline and ActivityNodes staggered across to provide more efficient and reliable communication.

### DETAILED DESCRIPTION OF INVENTION

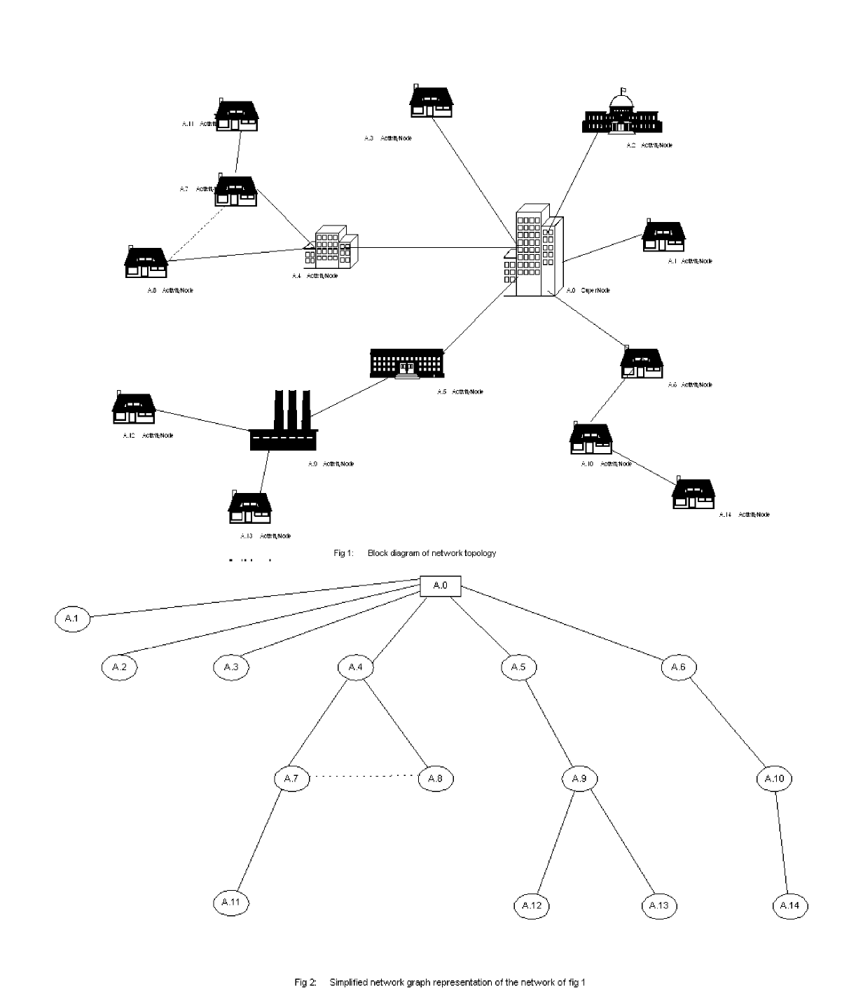

FIG. 1 is the representation for the network topology in line with an instance of the present invention. For simplicity a block diagram representation is used here and most of the details were not highlighted here; but subsequent diagram will reveal more of the network component details. The network topology include wireless utility management network with plurality of locations. The locations are labeled A.0 to A.16 [These locations will be interchangeably referred to as points, nodes, subscriber, customer in this document]. Although in this drawing the wireless nodes are shown as fixed within the network, but in practical application, due to flexibility of this mesh network, such locations can be mobile (i.e. moved from one part of the network to another or moved across networks).

The nodes in FIG. 1 are made up of two independent module integrated into one package. The modules are: the intelligent and repeater modules. The modules perform different functions and each has the following: a microcontroller unit, a transceiver unit, a dedicated antenna, memory unit and power supply unit. The intelligent unit has two additional units called the measurement unit and the actuator unit. A more comprehensive description of the role that each unit plays in the node will be provided later. Three very important components of the intelligent modules are the measurement, actuator and the transceiver units.

The measurement can take different form on these nodes. The form is dependent on the utility network application which the subscriber is a part of. The basic function for each unit is to measure the physical quantity of the utility that is passing through to the subscriber point. For some application, the measurement unit might be made of passive component, but in other applications, the unit might require power supply. When power is require by this unit, the power is taken from the inbuilt power supply for the node. The nodes in this network topology are designed to allow for the subscriber connection to the network to be managed from a remote location wirelessly. The actuator is the unit that makes this remote isolation possible. For most node cases, the actuator always requires some form of power. This power can either come from the primary supply or from the back up battery supply. The microcontroller unit controls the operation of all other units within the intelligent module.

Both the intelligent and repeater modules have wireless transceiver. These transceivers operate in the half duplex mode but each module on the node has a dedicated antenna. This switching for the antenna use is controlled by the microcontroller. Both transceivers in the intelligent and repeater module can be active at the same time, when such simultaneous transmit/receive is on, the module that is in the receive mode will ignore the signal from the other antenna, this way they overcome the challenge of interference.

The network depicted in FIG. 1 can contain as few as two nodes and as many as required. The processing power of the superNode is the only limitation for the number of nodes that can be on a network. But since this network is not for continues data transmission, the superNode is able to handle so many more nodes by staggering the data poll period from batch of subscriber location across the billing period. So the activity on the superNode is spread evenly across the billing or operation cycle. The subscriber node and the superNode on this network have ominidirectional antennas, with this the network expand in all direction. When new nodes are added to the network, they use any of their neighbors within radio frequency range as point of attachment and they immediately initiate the registration process on that network. The new node might attempt more than one request for attachment through its neighbor, when this is the case, the new node will forward its request to the neighbor with the highest signal strength. In cases where a new node could not successfully complete the registration process through one neighbor, the new node will attempt the same registration request through other neighbors.

In FIG. 1, as an example, when node A.8 was first added to the network, it found two neighbors within radio frequency range (nodes A.7 and A.4). The node will first send a request to attach to network to node A.7. For some reason, if this registration on network process for node A.8 did not complete successfully after a reasonable time, node A.8 will check for other potential point of attachment, it will then attempt to attach to the network through node A.4. Every valid node on a mesh is a potential point of attachment and expansion for the utility mesh. This way, the mesh can grow rapidly in all directions. The repeater module in each node is vital to the success and expansion of the network. To ensure that they are very efficient, the operation of these modules is streamlined such that they can quickly relay messages with very little delay. When a node sends a message to the superNode, it appends a preferred hop path. The preferred hop path is derived from the previous messages that the node sent and received from the superNode. The path that delivered the message within the shortest time is chosen as the preferred path. The priority list for preferred hop paths is created from the various delivery times.

When a repeater node receives a message, it will check to ensure that following are satisfied:
a] That the message is not from the intelligent module of the same node.
b] That header of the message contain its identification tag as the next node in the preferred hop path.

When the repeater affirms that its node ID is next in line on the preferred hop nodes, it will then strip its ID from the message header and relay the message to the next hop node. After the message is relayed, the repeater will then wait for an acknowledgement from that next node. In FIG. 1, node A.14 has initiated a message destined for the superNode [A.0], using nodes A.10 and A.6 as hop nodes. When the node A.14 first receives the broadcast of the message, the intelligent module on A.14 will detect that this is a message that destined for another node, so it will ignore that message. However, the repeater module on that same node will detect that it was chosen as a hop node. The repeater will then strip its node ID from the header message and then broadcast the message. This time, the original message plus the modified header are destined for node A.6. Node A.14 will then wait for an acknowledgment from A.6 to affirm that it received the message and relayed it successfully. When node A.6 receive and forward the message, the acknowledgement that node A.14 was expecting will be a new message, which has, a header modified by A.6, but the message body remains the same. Once this acknowledgement is received, node A.14 will then delete the message packet from its memory and prepare itself for normal operation.

However, if no acknowledgement was received after a long wait, node A.14 will broadcast the message again, this time hoping that it will reach node A.6. If A.6 fails to relay the message after successive retries, node A.14 will reconstitute the message header, it will remove A.6 from the list of preferred hop paths and then replace A.6 with another node that it deem to be active and reliable to help hop the message across to A.0. Once a message is dispatched from a source node, it becomes the responsibility of the nodes on the preferred hop path to ensure that that the message moves on in the hop path.

The nodes in the preferred hop path actively check to ensure that he next node down the list of hop node, passes the message on. By so doing, the task of passing massages across the network is distributed amongst the network nodes. However, if the originator of a message does not receive any acknowledgement from the superNode after a protracted wait, that node will then be forced to resend the message again. Instances where the re-transmission of such messages by the source node is necessary, the source node will select the next preferred hop path from the priority list of hop paths. In another instance, if A.12 is a new node on the network and has not yet generated a list of preferred hop path and it wish to send a multi-hop message to node A.0, node A.12 will add a unique signature to the header message, its neighbors will interpret this unique signature as NO PREFERRED HOP PATH. In this case, the first neighbor to receive this message will select a preferred hop path for it and forward to the next node. When multiple nodes receive a message with NO PREFFERED HOP PATH, each node will initiate a random wait period. The essence of the wait is to give random precedence to one of the nodes to act on the message.

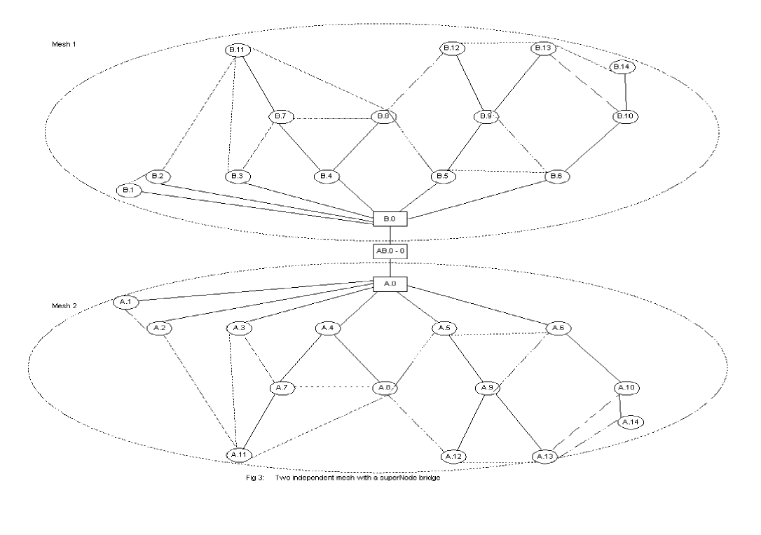

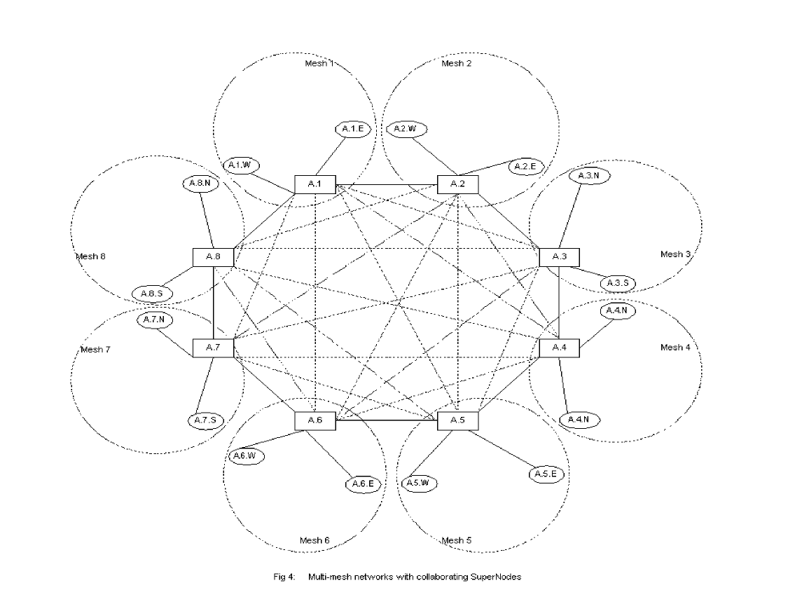

When control commands are sent from the superNode A.0 to one or more of the subscriber node, the line of communication or hop paths operate in a similar manner as described above. The only exception to this is the fact that the control commands from the superNode have precedence over all other messages that the repeater stations on the network might send. FIG. 2 is a network graph representation of the most basic of the mesh networks. For simplicity the nodes have been chosen to link to the next node using just one neighbor. FIG. 3 is one instance of the utility management network, this comprise of two separate mesh network that have been bridged by another superNode [AB.0-0]. This new network structure provide the following benefits:
The reliability of the network is dramatically increased. This is based on the fact that any of the superNodes can fully manage the operation of the entire network.
Maintenance of the superNodes can be planned and carried out online without having to shut the network down.
The performance profile for the two mesh networks can be produced as one virtual network.

The operation of the network is similar to the description for FIG. 1. The extra reliability on this network stems from the fact that is superNode A.0 should fail, node AB.0-0 will take over the operation of the mesh that node A.0 provided service for. Similarly, if node B.0 should also go down, node AB.0-0 will serve the two meshes. In this network structure, the three superNodes actively and constantly share information. FIG. 4: This is an instance of the network with distributed superNodes that collaborates. This network comprises of several independent meshes and each mesh managed by a superNode. The operations of the independent meshes are as described for the simple mesh in FIG. 1; but the distributed superNodes increases the reliability of the overall network. In this network structure, the superNodes share details about their local mesh during their idle time, the information shared across the superNodes are just basic structure for the mesh. The data exchanged might be basic, but it is vital for the successful rebuild of an independent mesh in the event of a mesh collapse [mesh collapse is the instance when a superNodes fails and all the activityNode are left as standalone unit and have to scout to attach to another neighboring mesh].

In the exemplary network structure of FIG. 4, if the superNode A.7 should fail such that mesh 7 collapses, the activityNodes within mesh 7 will fall into their stand-alone mode for a while. However, if node A.7.S is within radio frequency range of node A.6.W, the A.7.S will attempt to find a neighbor that is active and attached to a network. In this case, if it receives feed back from node A.6.W, it will then initiate an “attach to network request” through node A.6.W. When the superNode A.6 receives this request to attach to network, it will determine that this new node was registered to another mesh. Node A.6 could determine this based on the information that the superNode had exchanged earlier. Before the request is granted, superNode A.6 will attempt to contact its neighboring superNode A.7 to ascertain its status. If superNode A.7 is active and healthy, the attach request from node A.7.S will not be granted, but rather superNode A.6 will instruct node A.7.S to maintain connection to the mesh of superNode A.7. However, if superNode A.6 determines that its neighbor A.7 is not active and healthy, it will then grant the attach request to node A.7.S this new node will be linked to its mesh through node A.6.W. After the successful connection, superNode A.6 will store the ID of node A.7.S on a separate database table. This will be classified as the list of salvaged nodes. This list will be sent back to A.7 to help it rebuild its mesh when it finally recovers. Moreso, any changes applied to node A.7.S by superNode A.6 will be stored on a separate record set and this will be passed on to A.7 when it recovers.

On the other hand, node A.7.N will also attempt to attach to mesh 8 through node A.8.S, once it has successfully attached, the rest of the nodes in collapsed mesh 7 will attempt to attach to other mesh through nodes A.7.S and A.7.N. When the superNode A.7 recovers, it will contact it neighboring superNodes A.8 and A.6 to find out the list of activityNodes in its previous network that had joined their mesh. When this list is returned, the original superNode will then instruct its superNode neighbors to relinquish control over those nodes. The neighboring superNode will systematically relinquish control by instructing the nodes from the mesh that collapsed to connect back to their original superNode. Once the activityNodes are able to re-establish links with their original superNode, they will then break free from the superNode that salvaged them after their mesh collapse.

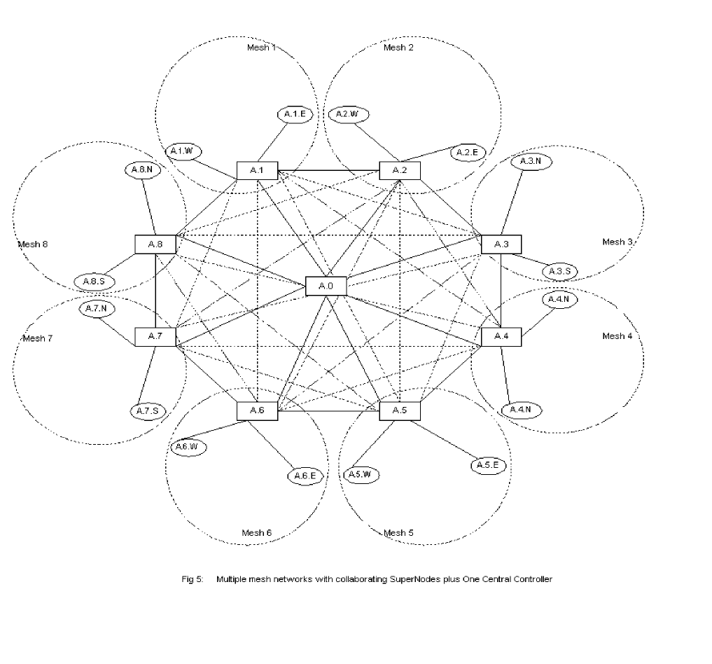

The exemplary network of FIG. 5 is similar in operation to that of FIG. 4, the only difference is the additional superNode A.0 that is central to the entire mesh. SuperNode A.0 is not committed to any mesh, but rather it plays the following roles for the superNodes.
Act a supervisory node for the other superNodes.
It replicates the list of nodes that belong to the individual meshes.
When a mesh collapses, it will receive the fail status from the failed superNode, it will then notify the neighboring superNode to accept attach request from a list of nodes that belong to the failed mesh.
Holds a replica of the list of salvaged nodes from a failed mesh and keeps a record of how they are split across other mesh.
Keeps a replica of all changes that were applied to the salvaged nodes from a failed mesh.
When a failed superNode recovers, the central superNode A.0 manages the process of rebuilding the failed mesh.

As stated earlier, the system described above can be applied to a utility network for water or gas supply to a community where the activityNodes are deployed at the subscriber points.

FIG. 7 is another instance of the network for pipeline monitoring. This network structure is different because each activityNode, although they have the ability to communicate in all direction, but their association in this mesh is based on their link to the nodes in the upstream and downstream direction. In this mesh network, the superNode can be positioned at any part of the network. But for better reliability, it is recommended to locate the superNode as close as possible to mid way of the pipeline. This way, when the link to a part of the mesh is lost, the entire pipeline mesh will not collapse. In the mesh of FIG. 7, node A.1.1 can communicate with nodes A.1.2, A.1.4, A.1.6, A.1.3, A.1.5 and A.1.7. The most important application for this network structure when deployed on a petroleum pipeline is the ability to preempt a failure and detect a leak on any section of the pipeline.

The techniques used here rely on the collaboration of all nodes on the pipeline mesh network. These nodes measure pressure at predetermined locations on the pipe and these measurement could either be intrusive or non intrusive. However to make the leak detection complete, each node will also measure the flow rate and the level of turbulence passing through it. In the pipeline mesh of FIG. 7, for the system to be able to detect a leak, the superNode will have to synchronize the internal clock of the activityNodes. The superNode will then instruct all the nodes along the pipeline to take snapshots of the pressure, flow and turbulence level at their location simultaneously. When the activityNodes have captured the flow signature through their point, the nodes will upload/send the data to the superNode. After the superNode has collated the signature data from all nodes on the pipeline mesh, it will pass the data across to the computer where the specialized pipeline signature analysis software will analyze the data.

The pipeline data analysis can take different form, but the most consistent is based on mathematical model that uses the pressure gradient between two points, the change in flow between two points and the level of turbulence recorded at two points to derive the location of leak or obstruction in a pipe. In the network of FIG. 7, if a leak had occurred at any point between nodes A.1.2 and A.1.4, these two nodes will record discrepancies in the pressure, flow and turbulence level readings. Depending on the severity of the leak, other nodes upstream and downstream of the two nodes will also record varying level of discrepancies. When the mathematical model linked to the superNode receive these changes in data from the nodes, it will perform the analysis to relate the varying levels of changes recorded to the relative distance of the leak with respect to the nodes that recorded the changes.

Neural network and fuzzy logic are other models that could be used to determine the location of a leak on a pipeline. The neural network approach is ideal for pipeline where the fluid flow through it is at steady rate and the pipeline is immune to external disturbance. The neural network model will first learn the signature of the pipeline at steady state. The pipeline signature is acquired by capturing the pressure, flow and turbulence level simultaneously at all node points on the pipeline mesh. When the neural network has learned the pipeline steady state signature, it will use this as a template. This signature learning process is repeated over different operating conditions until a predetermined confidence level is reached. During normal operation, the neural network will continue to acquire the pipeline signature at regular interval. The neural network will then compare the new signature with the original template signature. The fuzzy logic provides the inference for this signature comparison. This is achieved by applying a set of predefined rules to the comparison result.

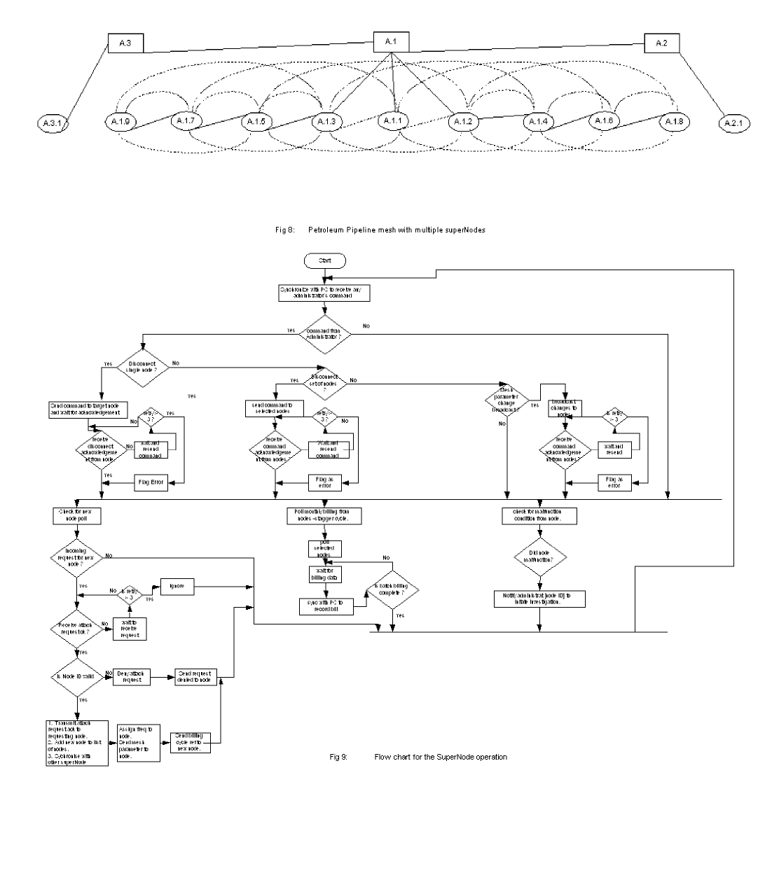

Other instances of this pipeline mesh can be deployed such that more than one superNode is located across the length of the pipe. When this is the case, the superNode locations are chosen such that they can communicate with other superNodes in the upstream and downstream direction. This network structure, with multiple superNodes is essential where reliability is required. FIG. 8 depicts one instance of such network. In this arrangement, if the superNode A.1 should fail, the nodes that were being served by the superNode will split and attach to superNodes A.2 and A.3 through nodes A.1.8 and A.1.9. This will ensure that the pipeline operation continues. FIG. 13 shows an exemplary network for monitoring multiple petroleum pipelines simultaneously. In this network configuration, if these pipelines are installed side by side such that the separation between them is less than the radio communication range for the ActivityNodes, staggering the different pipeline can increase then the distance between two activityNodes on the same pipe length. In FIG. 13, where the illustration represents 3 separate pipelines, the first activityNode A.1.1 is installed on pipeline 1 and the next activityNode A.2.1 is installed on pipeline 2, this next activityNode A.3.1 is installed on pipeline 3. This arrangement will continue until the entire pipelines are covered.

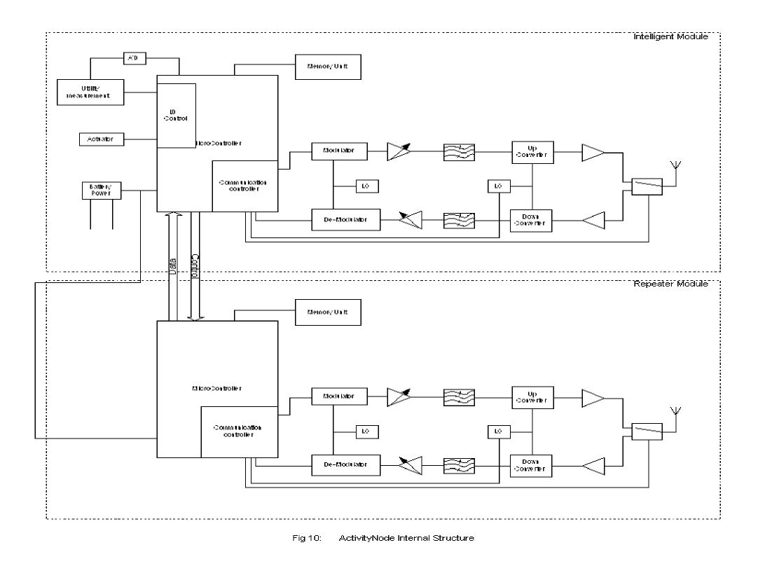

The superNodes perform the segregation of the ActivityNodes and identify the group of activityNodes that belong to pipeline 1 and those that belong to pipeline 2. Although, the activityNodes across pipelines can exchange and repeat data, their mesh structure is unique in terms of which pipeline they are attached to during the data analysis phase, the superNodes will only process data from the set of activityNode on the same pipe length during a batch process. In this configuration, when the superNode need to determine the performance of pipeline 1, it will send a data poll request to activityNodes A.1.1, A.1.2, A.1.3, A.1.4 and A.1.5. During this data poll, the network will allow other activityNodes on pipeline 2 and pipeline 3 to act as repeater stations when required. With this staggered node arrangement, fewer number of activityNodes can cover greater pipeline distance. FIG. 10 shows an exemplary block diagram of the activityNode that is installed at the subscriber point on the mesh network. In line with the present invention, the activityNode comprise of the intelligent and repeater module as highlighted on the diagram.

The intelligent module is made up of a microcontroller unit, which coordinates the operation. Connected to the microcontroller is the measurement unit; this captures the raw physical parameters that pass through the node onto the subscriber. When the measurement unit gets the physical parameter value, a fast Analog to Digital converter transforms the signal into the form that the micro-controller can process. Once the microcontroller receives the data, it applies the appropriate scaling to it, such that the value is in the right engineering unit. When this data scaling is complete, the microcontroller send the result to the memory unit where it is stored in two different fields; one as the cumulative meter reading and in the second as the monthly billing. When the superNode sends a monthly billing request with a unique ID to a particular activityNode, the message will reach both antennas on the node. The default position for the antenna switch, is the receive position. So in this case the message will reach the low noise amplifier which will now amplify the signal to improve its signal to noise ratio. The down-converter will then receive the signal; it will modify it and then pass it on to the [BPF] band pass filter. The signal from the filter is passed on to the variable gain amplifier. The signal finally passes through the de-modulator and reaches the microcontroller. Both micro controllers in the activityNodes will receive the request almost at the same time. But when the microcontroller on the repeater module decodes the message and discovers that the request is directed to the intelligent module, the repeater module will then ignore the message and allow the intelligent module to process it.

The intelligent module will process the request and generate the right response for the request and then send it back to the superNode. The outbound message to the superNode will go through the transmit path. Prior to finally transmission of the response, the intelligent module will send a handshake message to its local repeater module. The handshake message is to notify the local repeater the node is about to transmit a message and as such the local repeater should ignore the message. This technique is to ensure that the intelligent and repeater module do not simultaneously relay the same message. Similarly, when the activityNode receives the instruction to disconnect a subscriber point, the instruction follows the path described above and finally reaches the microcontroller. The Controller will process the request and affirms that it is a valid and authorized request to disconnect. The microcontroller will then de-energize the actuator to effect the disconnection. In an electricity distribution system, when the actuator is de-energized, the intelligent and repeater modules still maintain their primary power connection. This will mean that the node will continue to monitor the actuator terminals to detect when the subscriber or other intruders are tempering with a unit. For other application, a disconnect request from the superNode will mean that the microcontroller will actuate a solenoid valve.

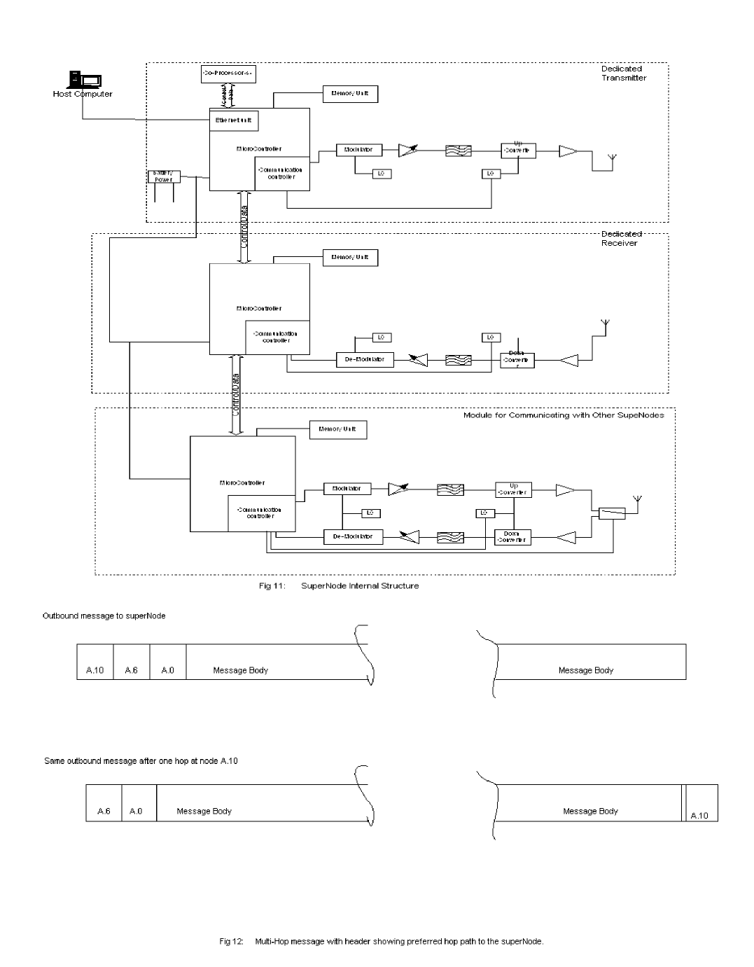

FIG. 11 shows the internal structure of the superNode. It is almost identical to the activityNode, the major difference being that the superNode has no physical parameter measurement, no actuator; instead, it has a high speed Ethernet link for connection to the computer. Moreso, the superNode has a more powerful micro-controller. The other very significant change in the superNode internal structure is the fact that each microcontroller is dedicated for either transmit or receive functions and the antennas are also dedicated. These dedicated components ensure that higher data throughput can be achieved. The two micro-controllers in the superNode can freely exchange data and command across their internal bus.

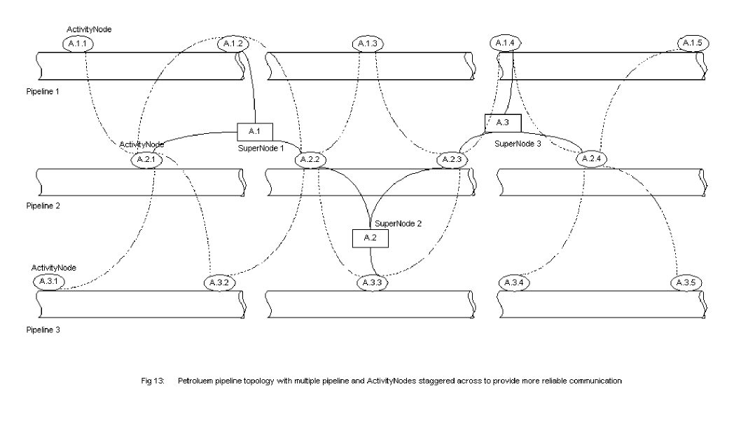

FIG. 12 is an exemplary message structure for an outbound message from node A.14 to the superNode (A.0) in the network topology depicted in FIG. 2. The first part of FIG. 12 shows the original message as it leaves the antennas of node A. 14. The header of that message shows the network ID of the preferred hop paths that was chosen for this message. In this case, nodes A.10 and A.6 were chosen as hop node in the chosen path. It is likely [depending on the transmission power of node A.14], that when the message left the antenna of node A.14, both nodes A.10 and A.6 will receive the message. When this happen, activityNode algorithm is such that both node will check the message to see if it is yet their turn to act as a repeater for the message. The nodes can determine this by looking at the message header and locate where their network ID falls. In this illustration, node A.6 will see that there is another node that needs to repeat the message before it. But node A.10 will see from the header that it has the priority to repeat the message, A.10 will simply repeat the message. The second part of FIG. 12 shows the modified message after node A.10 had repeated the message. Notice that node A.10 striped its network ID from the header before it repeated the message. This second message has now granted node A.6 the priority to repeat the message towards its destination superNode A.0.

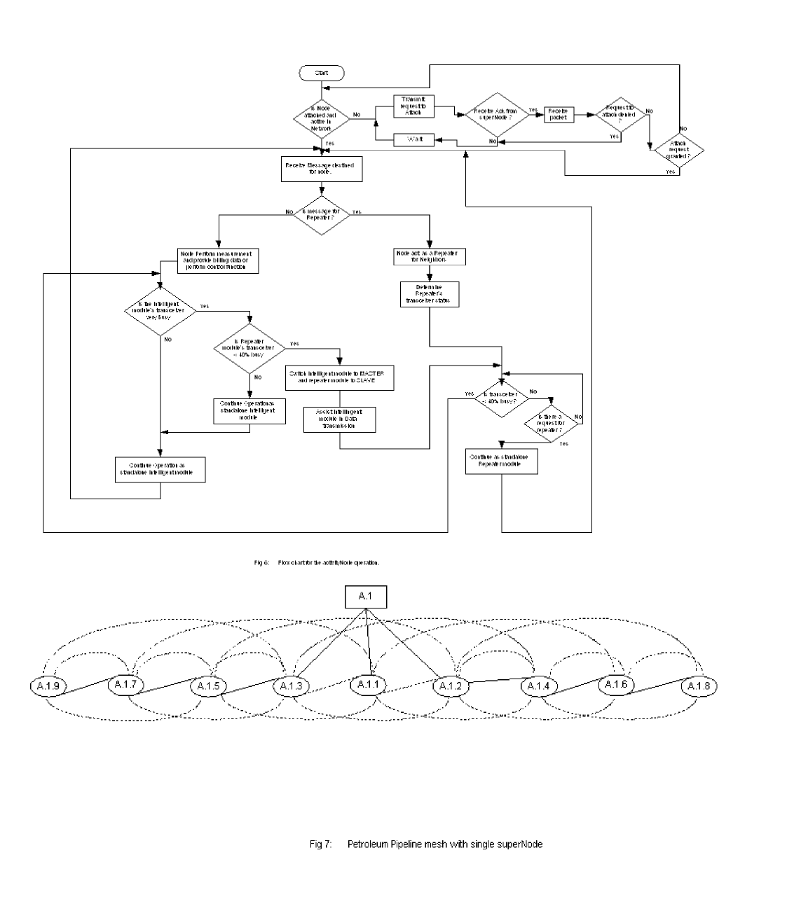

FIG. 6 shows an exemplary flow chart for the operation of an activityNode. When a node is activated, it checks to determine if it is registered to that network. If the node is new and had never been registered to a network, the new node will send a “request to attach to network” to any other node within its radio frequency range. The other nodes could be the superNode or other activityNode. This initial request to attach is sent through a default registration frequency channel, which all other active node in a network monitors periodically. If a neighboring activityNode receives the request, they will pass it on to the superNode. Upon receipt of this request, the superNode will validate the node ID. This is further explained later. If the node Identification is valid, the superNode will respond by sending the registration details back to the new node. When the new node receives this request, it will determine if the request was granted or denied. For the case where the request was granted, the node will configure its transceivers to the frequencies allocated for that network and also synchronize with the billing cycle. At this stage the node is active and part of the network. The node will begin to monitor incoming messages and respond accordingly.

When a command from the superNode comes as an inbound message, the new node will decode this command and act accordingly. Alongside receiving incoming messages, the node is constantly accessing and updating its record for utility measurement. When there is the need for the new node to transmit messages, the node will determine the volume of data that it need to transmit and estimate the time it will take to complete the transmission. If the node determines that it will take too long to complete the transmission, that intelligent module in that node will then enlist the services of its local repeater module so as to expedite the transmission. The repeater module on that node will only honor this request to assist if it was not very busy. The intelligent module will delegate some of the data to its repeater module if it accepted to assist in the transmission. Although the repeater module can receive data and instruction from the intelligent module, it can only send data back to the intelligent module. The repeater module cannot send instructions to the intelligent module. This restriction is required to ensure that no rogue node/neighbor will send unauthorized instruction that will be executed on the intelligent module side. [The actuators and measurement units of a node cannot be altered by instructions from an external node, which the intelligent module did not verify]. The control scheme in this network is designed such that the intelligent module of a node will only execute instructions that have originated from the superNode or from its internal operation.

The flow chart of FIG. 9 illustrates the operations of the superNode. The operations of the superNode are synchronized closely with the processing and analysis that is performed on the computer. The computer is vital to the strength of the superNode because, it is through the computer that third party analytical and processing application can be deployed to the superNode. The computer is connected to the superNode hardware through an Ethernet port. Through this port and the computer program, an administrator can gain access to the internal hardware and operations of the superNode. From the flow chart, the administrator can issue command or configuration for the superNode to perform. Some of the common command that the superNode issues include: instruction to disconnect a single node, or command to disconnect a set of node or changes to network parameters that will be sent to all nodes on the network. The lower part of the superNode flow chart highlight some of the background operations that the superNode perform. Since these operations occur routinely, the superNode delegates these processes to its co-processor(s). Depending on the number of nodes that are on the network, the number and power of the co-processors can be increased to match the processing requirements.

### SUMMARY

A wireless distributed wireless utility management network comprising, plurality of subscriber units called ActivityNodes, located across a wide geographical area forming a mesh. Wherein the utility being distributed could be petroleum products, electricity, gas or water to consumers or subscribers at plurality of locations.

An actuator or switching device integrated into the subscriber units and wherein the actuating or switching device ensure that an ActivityNode can be connected to or disconnected from the main utility distribution Wherein the ActivityNode in the network further comprising, a wireless transceiver with broadbeam antenna, that allows one activityNode to communicate with plurality of neighboring activityNode within communication range in different directions. Plurality of activityNodes could be organized in a network to form a wireless utility mesh network, which can expand in different directions.

Each activityNode on this mesh network is a potential point for attachment for other nodes that wish to join the network. In this wireless utility mesh network, the activityNodes can act as repeater stations for its neighbors and allow messages to move from one end of the mesh to another through multiple hops using any of the activityNode within communication range and in the path of the message transfer.

The activityNode serve two primary purposes; it acts as a meter to measure the quantity of the “utility” being distributed that is passing through it and thus generate a bill for the utility consumed by a subscriber over a billing cycle. The activityNode also facilitate connection to or disconnection from the utility distribution.

The utility mesh network, wherein at least one superNode exist such that, the superNode acts as a central control and management point for a plurality of activityNodes in a wireless utility mesh network.

A superNode and plurality of ActivityNodes that can communicate with each other through one or multiple message hops form an Independent Wireless Utility Mesh Network and a superNode can also communicate with Plurality of neighboring superNodes through dedicate wireless transceiver coupled to a broadbeam antenna.

Plurality of ActivityNodes and at least one superNode form an Independent Wireless Utility Mesh Network where the superNode synchronizes and manages the operations of the activityNode in the network and when two or more Independent Wireless Mesh Networks exist, and are not within communication range of each other, one or more superNodes could be positioned strategically such that they form a bridge across the independent Wireless Mesh Network and the resultant network is called a Distributed Wireless Mesh Network.

Another kind of Distributed Wireless Mesh Network can be formed when a plurality of SuperNodes are positioned at strategic locations on the network, such that the SuperNodes can communicate with plurality of activityNodes and plurality of other SuperNodes.

The utility mesh system, wherein the activityNodes can have different types of sensor and actuators depending on the utility distribution system.

The network, wherein the activityNode has two transceivers connected to separate antennas. The transceivers are configured to receive or transmit a radio frequency signal using channels from a number of non-conflicting frequency channels and on any of these activityNodes only two frequency channels will be in use at a time and the SuperNodes decide the frequency channels that the activityNodes will communicate through to minimize collision on the mesh.

From the two active frequency channels allocated to the activityNodes, one serve as a transmit channel and the other for receive. The activityNode comprise of two distinct modules called; Intelligent Module and Repeater Module. 7he intelligent module in the activityNode is the unit that manages the internal operation of the activityNode and has exclusive access to the actuating and measurement devices.

The intelligent module, which manages the operation of the sensing unit [that measures the physical quantity of the utility passing through the activityNode on the network], the intelligent module is made up of a micro-controller/microprocessor, the memory unit, analogue to digital converter, the switching interface and the communication module.

Wherein the intelligent module can pass instruction on to the repeater module and receive feedback. It can also assume the master role and make the “Repeater Module” a slave. In this master-slave arrangement if the intelligent module is busy, it can interrogate the repeater module to find out if it is busy or idle and if the repeater module is idle. The intelligent module can then utilize the free transceiver on the repeater module and then turn it into a dedicated transmitter.

Similarly, the repeater module whilst acting as a dedicated transmitter will continue to check for incoming request from its neighbor to serve as a repeater and If no incoming request, the repeater module will continue to act as a dedicate transmitter for the intelligent module until a new repeater request is received. Where in there is an incoming request from a neighbor to the repeater module, the repeater will complete the last transmission and notify the intelligent module about the incoming request.

When the notification is acknowledge by the intelligent module, then the repeater module will switch off from slave mode and assume the responsibility of a repeater for its neighbors and repeater module is a unit within the activityNode that is dedicated to help the neighboring activityNodes hop/repeat their messages towards the superNode. The repeater module consists of the following; a microcontroller/microprocessor, memory unit, transceiver, decoder and switching system for the transceiver to the antenna and also for switching the power supply source.

During normal operation, the repeater module cannot issue instruction to the intelligent module and as such the repeater module cannot be master to the intelligent module and as such the repeater cannot gain direct access to the actuators and the analogue utility measurement on the activityNode. The Intelligent and repeater modules both have dedicated ominidirectional antennas.

The activityNode design allows both the repeater and intelligent modules to have the option of running off dual power supply. This power supply can have a combination of either battery or mains powered.

Wherein the repeater module receive data that is meant for the intelligent module, it will pass the data across to the intelligent module through the internal databus that they share. An integrated decoder unit, helps the repeater to identify the source of the message and also identify the next neighbor that it will use for the message hop. The repeater module keeps a list of its neighbors that are most reliable in hopping messages towards the superNode. A similar list of the most reliable nodes used for hopping a control instruction from the superNode toward the other activityNodes on the mesh also exist on the repeater module.

Wherein an activityNode send a message through its intelligent module to the next hop in the preferred hop path, the module waits for an acknowledgement from that next hop point. If no acknowledgement is received after a predefined wait time, it will assume that that next hop node was unable to forward the message to the superNode; the intelligent module will then alter the preferred hop path by changing the next hop node with another neighbor from its local list of reliable hop nodes. This new path will become the preferred hop path, the repeater module will only change this path if the message could still not be sent through the path chosen.

The frequency channels for the activityNodes are generated based on either Code Division Multiple Access (CDMA) or Frequency Division Multiple Access (FDMA) or Time Division Multiple Access (TDMA). The activityNode can vary it transmission power, this allow the communication coverage distance to change on demand. When the nodes operate on full power mode, the activityNode can cover a radio frequency range of several hundreds of meters without using a neighboring repeater station. This flexibility and potential for long transmission range is the basis for deploying this network across a wide geographic area.

A rechargeable battery pack integrated onto the activityNodes, such that the battery unit can be charged from a variety of sources depending on the application. Some of the possible sources for charging the battery include:
Solar panels
Portable turbine unit
Step down DC power supply
Etc . . .

The activityNode has at least two non-conflicting frequency channels dedicated for registration when added to a new network and when a new activityNode is added to an existing network, the repeater module will not function until the activityNode receives the attach request granted message from the superNode on the mesh network.

When a new activityNode is added to an existing mesh network, one of its non-conflicting channel, serve as a transmit channel for upload of the configuration details to the SuperNode. This upload of details can go through one or plurality of neighboring activityNodes. The second registration frequency channel on the activityNode will receive the registration confirmation and communication details from the superNode for that Independent mesh. Prior to a new activityNode being added to an existing Independent mesh, the unique identification details for that activityNode will be added to the superNode's database of points on that mesh.

When a new activityNode is added to an existing Independent mesh network, the activityNode will send a request for activation to the superNode using one of the default registration channels. When the superNode receives an activation request from a new activityNode, it checks and authenticate the new activityNode details from its registers of potential points on the mesh; If the new activityNode is recognized as a valid node, the superNode will send an “activation granted” message back to the new activityNode using the second registration channel.

In the wireless utility mesh network, wherein an activityNode receives the activation message with details, it becomes an active member of the wireless control mesh and can participate fully in the network operation. Request and data flow from the activityNodes toward the superNodes, whilst control signals/instruction flow from the superNodes down to the activityNodes.

The activityNodes can communicate with one or plurality of SuperNodes. In every network deployed, an activityNode will only establish active communication with only one superNode at a time and the communication between them can hop across one or more other activityNodes.

When this wireless utility mesh network system is deployed on an electricity distribution system to consumer outlets, where the consumer outlet can be residential homes in urban or rural communities and in other cases, the consumer outlet could be corporate office and/or industrial site. The resulting network is a Distributed Wireless Power Management Network comprising:
plurality of ActivityNodes
plurality of SuperNodes

Wherein the activityNode, measures the amount of electrical power passing through it with its intelligent module and stores the cumulative usage until the superNode initiates a billing cycle. When the superNode initiates a billing cycle, a bill request is sent to all activityNode within that Independent Wireless Mesh Network and the activityNodes will respond to this request by sending its cumulative value through its intelligent module towards the superNode.

The billing cycle request from the SuperNode may go through several hops, so the target activityNode will attempt to identify the hops used by the request. Each node in the hop path will append its unique ID to the original message before repeating the message. From the request, the activityNode will strip and concatenate the unique ID that each hop point appended and the nodes identified will form the preferred transmission path for the response to the superNode.

When the activityNode switches to the backup battery supply following a failure of the primary source of power, the node will modify its operations and will notify the superNode that it has switched to battery power mode. It will then de-energize its electromechanical contact/device to the OPEN position, this is the safe position to ensure that no power flows to the subscriber, and will not experience power surge or spikes when the primary supply for the activityNode is restored.

Wherein the activityNode is in battery power mode, the node will begin to monitor its battery level and also will measurement unit to see if power is still flowing through to the subscriber at that point. If no power flow is recorded by the instrument and measurement, the activityNode will report a supply failure at that node point back to the superNode. However, if the activityNode detect that there is still power passing through its terminal to the subscriber, activityNode will there report an abnormal operation back to the superNode and this report will force the superNode to trigger an investigation into this anomaly.

When an activityNode is in battery power mode, it sends a broadcast to its immediate neighbors to inform them that it is in battery power mode. This message will then cause its neighbors to exclude it from their list of preferred hop paths and that node will not act as a repeater for its immediate neighbors, but it can send requests to the superNode through its neighbors. However, an activityNode in battery power mode can still receive instruction from the superNode for its internal processing, in this mode of operation, the activityNode is considered to be a standalone unit.

In a wireless utility mesh network, the superNode collates the power usage data from the activityNodes on the wireless mesh and use this data to build a profile of the power utilization, the superNode will use this report alongside the constraints for electricity distribution to pre-empt any fault/failure that my arise on the network. The superNode can send a DISCONNECT instruction to one or plurality of activityNode(s) instructing then to disconnect the utility supply to that subscriber node. The need to disconnect a particular activityNode from a network may be due to any of the reasons below; Emergency, Load Shedding/Maintenance or Payment Overdue.

Wherein the superNode initiates the instruction for one or plurality of activityNodes to isolate their subscribers from the electricity distribution and upon successful execution of this instruction by the activityNode(s), the node(s) will monitor their measurement unit to detect if power is still passing through to the subscriber; the node(s) will report any abnormal operation to the superNode. Upon successful isolation by the activityNode based on instruction from the superNode, its internal circuitry will continue to draw power form the primary supply and it will still act as a repeater node for its neighbors.

The activityNode assembly is based on a temper proof design and the electromechanical actuator units have micro-switches. During normal operation, these switches are in the CLOSE position. If the unit is opened/tempered with during normal operation, one or more of the switches fall to the open position, this will be detected by the microcontroller in the activityNode and the activityNode will immediately send an alert to the superNode reporting that the unit has been tempered.

When the alert from an activityNode reaches the superNode, it is recorded as an alarm. The superNode has the option to inhibit the alarm for a particular activityNode. This function allows for maintenance work on the activityNode.

The superNode can use the Ethernet port to share data gathered from all activityNodes with a third party specialized applications on a computer. The third party applications that reside on the computer can provide processing power for analysis and management for the utility network. The result of such analysis can be a representation of the distribution profile for the utility mesh network.

Wherein the network is modified and adapted for domestic and industrial gas or water supply network for a large geographical area and where the modifications applied to this network includes; the enclosure for the activityNode designed such that it will provide ingress protection from the domestic gas in the distribution network and non-intrusive measurement will be used to measure the usage at the subscriber point.

When non-intrusive measurement is used on the activityNode, solar panels will be the preferred option for charging the battery pack. In the option of non-intrusive measurement, it will be optional for the activityNode to have control actuators and another option for charging the battery pack will be through a mini turbine integrated with the unit and propelled by the gas flow.

However, when an intrusive measurement approach is used for a particular subscriber, then the activityNode will have the option to control a solenoid valve fitted as standard. The solenoid valve can be used to isolate gas supply to a subscriber and this is designed such that it will close gently to minimize the impact on the system. The safe fail mode and safe position for the actuator in this system is the CLOSED position and when the activityNode is in the battery-powered mode, the solenoid valve attached to the node will operate to the CLOSED position. The activityNode will then send a message to the superNode to inform it that the valve is in the CLOSED position and the superNode takes this valve position into consideration as it manages the pressure on the network.

Further modification could be applied to the network and adapted to serve as petroleum pipeline monitoring over a wide geographical area and the modifications applied to this network include:

The activityNodes are arranged in series along the pipeline and one activityNode can communicate with three or more of its immediate neighbor in the upstream and downstream direction. The activityNode can send a request to the superNode through multiple hops, where the first hop must be through one of its immediate neighbors within wireless transmission range in the upstream or downstream direction. This network is specially adapted to detect leaks or failures along the petroleum pipeline length.

The superNode can gather and analyze data from the ActivityNodes to generate a profile/pressure-gradient for the product distribution in the pipeline. Any abnormalities in the distribution profile will then be analyzed further to determine the location of a leak or failure. This second phase of the detailed profile analysis by the superNode takes into account the flow dynamics.

What is claimed is:

1. A wireless distributed utility management and control mesh network comprising;
plurality of wireless transceiver units called ActivityNodes, located across a wide geographical area forming a mesh network with plurality of central control and management transceiver units called a SuperNodes; and
wherein the activityNodes have microcontroller, sensing and actuator units such that this mesh network can be deployed onto utilities like petroleum product, electricity, domestic gas and water distribution system.

2. The network of claim 1, wherein the activityNode consist of two sub units called the intelligent and the repeater units; and
the intelligent unit comprise of the sensing device that measure the quantity of utility passing through the activityNode onto the subscriber and the repeater unit makes it possible for the activityNode to act as a repeater node for other activityNodes within radio transmission range.

3. The actuator in the ActivityNode could be an electrical or mechanical device, which allows a subscriber to be connected to or disconnected from the utility distribution system;
wherein the superNode manages the operation of the mesh network and decides when a subscriber node is connected or disconnected from the network.

4. The network of claim 1, wherein the mesh network can organize itself such that any valid activityNode on the mesh is a potential point of attachment for other activityNodes to the network and this allows the network to grow in different direction over a very large geographical area;
the activityNode communication can span several hundreds of meter and the intelligent unit in this node can vary the transmission power, which in turn determine the range of transmission.

5. the network of claim 1, wherein the activityNode and SuperNode can use two non-conflicting channels for communication and the channels can be derived using either Code Division Multiple Access (CDMA), Frequency Division Multiple Access (FDMA), Time Division Multiple Access (TDMA) or other techniques;
the communication between an activityNode and the superNode can either be direct or could hop over plurality of neighboring activityNodes before it reaches the superNode;
the activityNode chooses a preferred hop path for messages sent to and received from the superNode, the hop path consist of the neighboring activityNodes.

6. In the activityNode, the intelligent unit has exclusive access and control over the sensor and actuator devices;
the intelligent unit can transmit data through the repeater unit on that node, but the reverse is not permitted;
the activityNode can take power from different sources depending on the utility distribution;
for electricity distribution, the power can come from the mains supply with a backup battery system which is charged from the mains;
for petroleum product, water or domestic gas distribution, a mini turbine which is driven by the fluid flowing through the pipe or a solar panel can be used to charge a battery power supply system.

7. The intelligent unit in the activityNode can generate bill for the measure of utility that passed through it for the billing cycle;
the superNode synchronize all activityNode on the mesh to the start and end of the billing cycle; and
although more than one superNode can be present in a mesh network, only one can engage an activityNode unit in communication at any point in time;
wherein plurality of superNodes are present in a mesh, they can form virtual mesh networks with batches of activityNode, such that within a mesh, they could be several other sub-mesh networks called “Independent Wireless Utility Network” and an aggregate of Independent Wireless Utility Network will form a parent network called “Distributed Wireless Utility Mesh Network”.

8. The system of claim 1, such that the Intelligent and Repeater units of the activityNode have separate antennas, which are dedicated for their communication;
moreso, the superNode have two dedicated transceivers, one for communication with plurality of activityNodes and the other for communication with plurality of neighboring superNodes;
the superNode also have a high speed Ethernet port that allows it to be integrated to a Computer system which can have third party application and resource that the superNode can use when necessary.

9. The method of claim 8, wherein the superNode can use the application or processing power from a computer to analyze the data from a set of activityNodes in a mesh and thus use the result to determine the performance of the mesh network; and
this performance analysis could be extended to allow the superNode preempt or detect a fault on the utility distribution system.

10. The network of claim 1, wherein an activityNode is added to an existing mesh, network, it will send a request to attach using one of its default registration channels through any of the neighboring nodes on that network to the superNode;
he superNode will grant or deny the request to attach depending on the details of the new activityNode;
he decision of the superNode is relayed back top the requesting node through one of its default registration channel.

11. The method of claim 1, in an Electricity distribution system to consumer outlets; and
a single or three-phase sensor monitors the amount of power passing through onto the consumer and generates a bill based on this when requested by the superNode;
wherein a single phase or three phase actuator is built into the activityNode such that the superNode can instruct the activityNode to connect or disconnect the consumer when necessary; and
when a consumer point is disconnected from the utility distribution, the intelligent module still draw power for its internal operation from the mains supply and it will continue to check if power is still passing through to the consumer or if the node is tempered.

12. Method of claim 11, wherein the mesh network is modified and adapted for domestic gas or water supply network for a large geographical area;
where the enclosure for the activityNode is modified such that it will provide ingress protection; and
the sensing device could be intrusive on non-intrusive;
the actuator device will make it possible to control the flow of gas or water and the primary source of power for the activityNode in such installation is from the battery supply which can be recharged from a solar panel or turbine.

13. The method of claim 11, wherein the network is modified and adapted for petroleum pipeline monitoring over a wide geographical area and the modifications applied to this network include:
the activityNodes are arranged in series along the pipeline; and
one activityNode can communicate with three or more of its immediate neighbor in the upstream and downstream direction.

14. the activityNode can send a request to the superNode through multiple hops, where the first hop must be through one of its immediate neighbors within wireless transmission range in the upstream or downstream direction;
this network is specially adapted to detect leaks or failures along the petroleum pipeline length; and
the superNode can gather and analyze data from the ActivityNodes to generate a profile/pressure-gradient for the product distribution in the pipeline;
abnormalities in the distribution profile will then be analyzed further to determine the location of a leak or failure;
this second phase of the detailed profile analysis by the superNode takes into account the flow dynamics.
